(19) United States
(12) Patent Application Publication
(10) Pub. No.: US 2013/0278858 A1
(43) Pub. Date: Oct. 24, 2013

(54) DISPLAY DEVICE AND METHOD FOR MANUFACTURING THE SAME

(71) Applicant: JAPAN DISPLAY EAST INC., Mobara-shi (JP)

(72) Inventor: Satoshi HASHIMOTO, Chiba (JP)

(73) Assignee: Japan Display East Inc., Mobara-shi (JP)

(21) Appl. No.: 13/851,156

(22) Filed: Mar. 27, 2013

(30) Foreign Application Priority Data
Apr. 23, 2012 (JP) 2012-097274

(51) Int. Cl. G02F 1/1335

(52) U.S. Cl. CPC G02F 1/133512
USPC 349/58; 349/108; 445/25

(57) ABSTRACT

A display device includes: a first substrate which has an image display region; colored layers of plural colors which are arranged in rows on the first substrate and constitute a color filter in the image display region; and a black matrix which is provided for preventing leakage of light as well as color mixing between the colored layers arranged adjacent to each other. The black matrix includes a frame-shaped portion which surrounds the image display region. The frame-shaped portion is formed such that the frame-shaped portion has a notch on an outer side thereof and covers a periphery of the first substrate except for the notch where the frame-shaped portion does not cover the periphery of the first substrate. The colored layer of at least one color is arranged in the notch.

### CROSS-REFERENCE TO RELATED APPLICATION

The present application claims priority from Japanese application JP2012-097274 filed on Apr. 23, 2012, the content of which is hereby incorporated by reference into this application.

### BACKGROUND OF THE INVENTION

1. Field of the Invention

The present invention relates to a display device and a method for manufacturing the display device.

2. Description of the Related Art

A black matrix is formed on a display panel for blocking undesired light. The black matrix is formed while avoiding an edge portion of the display panel so as to make a positioning mark viewable. For example, JP 2008-257014 A discloses a technique where a positioning mark is used for confirming a position where an end-sealing material which closes a liquid crystal injecting opening is provided.

In a display device provided with a backlight, the prevention of leakage of light is important. However, the black matrix is not formed on an edge portion of a display panel and hence, leakage of light occurs. Although leakage of light can be obviated by forming the black matrix also on the edge portion of the display panel, a positioning mark is not viewable in this case.

### SUMMARY OF THE INVENTION

It is an object of the present invention to provide a display device provided with a mark which can suppress leakage of light and a method for manufacturing the display device.

(1) According to one aspect of the present invention, there is provided a display device which includes: a substrate which has an image display region; colored layers of plural colors which are arranged in rows on the substrate and constitute a color filter in the image display region; and a black matrix which is provided for preventing leakage of light as well as color mixing between the colored layers arranged adjacent to each other, wherein the black matrix includes a frame-shaped portion which surrounds the image display region, the frame-shaped portion is formed such that the frame-shaped portion has a notch on an outer side thereof and covers a periphery of the substrate except for the notch where the frame-shaped portion does not cover the periphery of the substrate, and the colored layer of at least one color is arranged in the notch. According to the present invention, the colored layer is arranged in the notch formed in the black matrix and hence, the colored layer can be used as a positioning mark. Due to the provision of the colored layer, leakage of light can be suppressed more effectively compared to a mark formed of only a notch.

(2) In the display device having the constitution (1), the plural colors may include at least three colors consisting of red, green and blue, and at least the blue colored layer may be arranged in the notch.

(3) In the display device having the constitution (1) or (2), the plural colors may include at least three colors consisting of red, green and blue, and the colored layers of remaining colors after removing at least one color from the three colors may be arranged in the notch.

(4) In the display device having any one of the constitutions (1) to (3), the colored layers of two or more colors may be stacked in the notch.

(5) In the display device having any one of the constitutions (1) to (4), the display device may further include a second substrate which faces, assuming that the substrate is a first substrate, the first substrate; a liquid crystal material which is interposed between the first substrate and the second substrate; a seal which surrounds the liquid crystal material between the first substrate and the second substrate and includes a slit; and an end-sealing material which closes the slit in the seal, wherein the black matrix may have the notch in respective regions which form a pair and sandwich the slit therebetween.

(6) In the display device having any one of the constitutions (1) to (5), the display device may further include a frame which surrounds the substrate, wherein the frame may have a mark which faces the notch in an opposed manner.

(7) According to another aspect of the present invention, there is provided a method for manufacturing a display device which includes: a first substrate which has an image display region; colored layers of plural colors which are arranged in rows on the first substrate and constitute a color filter in the image display region; a black matrix which is provided for preventing leakage of light as well as color mixing between the colored layers arranged adjacent to each other; a second substrate which faces the first substrate in an opposed manner; and a seal which surrounds a space formed between the first substrate and the second substrate and includes a slit, the black matrix including a frame-shaped portion which surrounds the image display region, and the frame-shaped portion being formed such that the frame-shaped portion has a notch in respective regions which form a pair and sandwich the slit on an outer side of the frame-shaped portion and covers a periphery of the first substrate except for the notch where the frame-shaped portion does not cover the periphery of the first substrate, wherein the method includes the steps of: preparing an empty cell where the colored layer of at least one color is arranged in the notch; injecting a liquid crystal material into the empty cell; and sealing the slit in the seal by an end-sealing material using the colored layer of at least one color arranged in the notch as a mark. According to the present invention, the colored layer is arranged in the notch formed in the black matrix and hence, the colored layer can be used as a positioning mark for providing an end-sealing material. Due to the provision of the colored layer, leakage of light can be suppressed more effectively compared to a mark formed of only a notch.

### BRIEF DESCRIPTION OF THE DRAWINGS

FIG. 1 is a cross-sectional view of a display device according to an embodiment of the present invention;

FIG. 2 is an enlarged cross-sectional view of a liquid crystal display panel;

FIG. 3 is a plan view of the liquid crystal display panel;

FIG. 4 is a plan view of a black matrix;

FIG. 5 is a view for explaining a method for manufacturing the display device according to the embodiment of the present invention;

FIG. 6 is a view for explaining a black matrix material for multipiece-simultaneous-manufacturing cells shown in FIG. 5; and

FIG. 7 is a view showing a modification of the embodiment of the present invention.

### DETAILED DESCRIPTION OF THE INVENTION

Hereinafter, an embodiment of the present invention is explained in conjunction with drawings.

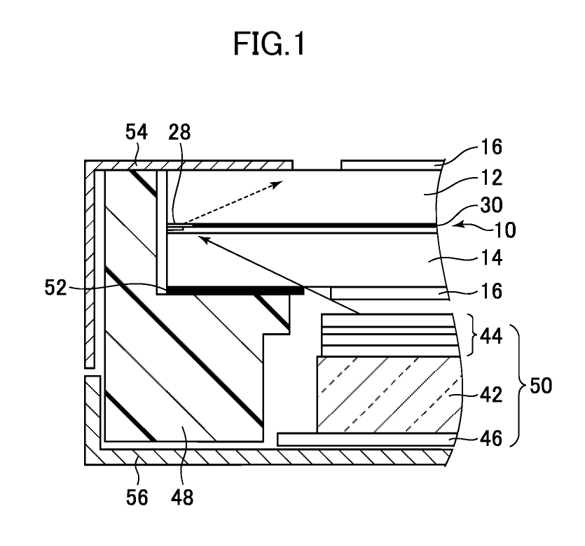

FIG. 1 is a cross-sectional view of a display device according to the embodiment of the present invention. The display device according to this embodiment is a liquid crystal display device which has a liquid crystal display panel 10. The present invention is, however, also applicable to other display devices such as an organic EL display device having an organic EL (Electro Luminescence) display panel, for example.

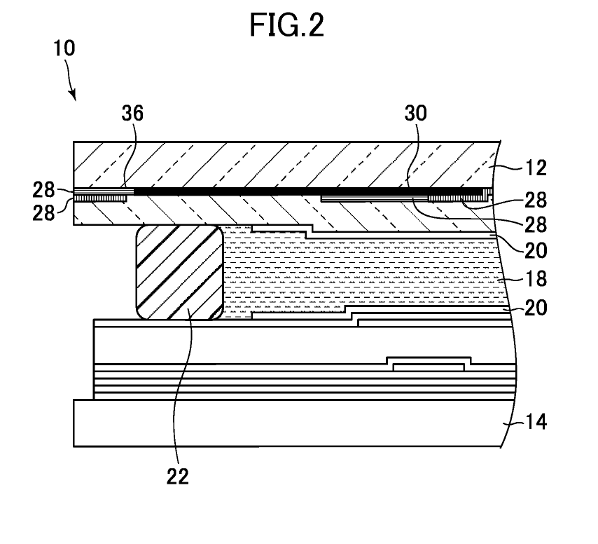

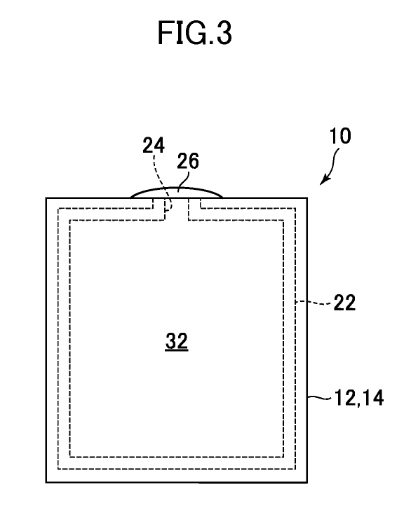

FIG. 2 is an enlarged cross-sectional view of the liquid crystal display panel 10. FIG. 3 is a plan view of the liquid crystal display panel 10. The liquid crystal display panel 10 is a panel for an image display. The liquid crystal panel includes a first substrate 12 and a second substrate 14 which overlap with each other with a gap formed therebetween. A polarizer 16 shown in FIG. 1 is laminated on a surface of the first substrate 12 and a surface of the second substrate 14 which are arranged on sides opposite to each other respectively. A liquid crystal material 18 is interposed between the first substrate 12 and the second substrate 14. The liquid crystal material 18 is sandwiched between alignment films 20 (FIG. 2) which are formed on a surface of the first substrate 12 and a surface of the second substrate 14 which face each other in an opposed manner respectively. As shown in FIG. 3, the liquid crystal material 18 is surrounded by a seal 22. A slit 24 is formed in the seal 22, and the slit 24 is sealed by an end-sealing material 26.

The first substrate 12 is a color filter substrate. The second substrate 14 is a TFT substrate (or an array substrate) which includes thin film transistors, pixel electrodes, lines and the like not shown in the drawing and on which a plurality of films are stacked.

Colored layers 28 of plural colors are arranged in rows on the first substrate 12. The plural colors include at least three colors consisting of red, green and blue. The colored layers 28 of plural colors form a color filter within an image display region 32. The display device includes a black matrix 30. The black matrix 30 is formed on the surface of the first substrate 12 which faces the second substrate 14 in an opposed manner. The black matrix 30 prevents leakage of light as well as color mixing between the colored layers 28 arranged adjacent to each other. The black matrix 30 and the colored layers 28 are respectively formed using a resin.

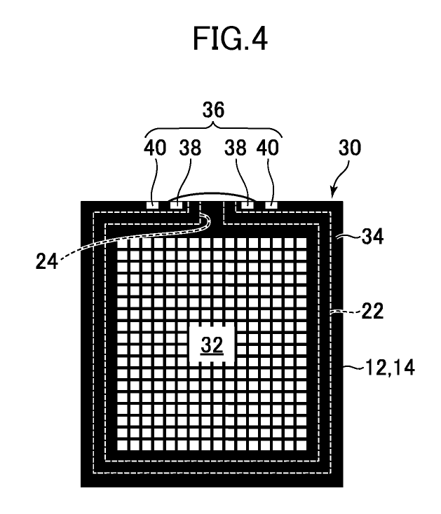

FIG. 4 is a plan view of the black matrix 30. The black matrix 30 includes a frame-shaped portion 34 which surrounds the image display region 32. The frame-shaped portion 34 includes notches 36 on an outer side thereof. The black matrix 30 is formed such that the black matrix 30 covers the periphery of the first substrate 12 except for the notches 36 where the black matrix 30 does not cover the periphery of the first substrate 12. The black matrix 30 has the notches 36 in respective regions which form a pair and sandwich the slit 24 formed in the seal 22 therebetween. To be more specific, a pair of first notches 38 is formed such that the first notches 38 sandwich the slit 24 therebetween, and a pair of second notches 40 is formed such that the second notches 40 sandwich the pair of first notches 38 therebetween.

As shown in FIG. 2, the colored layer 28 of at least one color (at least blue) is arranged in the notch 36. The colored layers 28 of two or more colors are stacked in the notch 36. For example, the colored layers 28 of remaining colors after removing at least one color from three colors (for example, two colors of blue and red, or two colors of blue and green) are arranged in the notch 36.

According to this embodiment, the colored layers 28 are arranged in the notch 36 formed in the black matrix 30 and hence, these colored layers 28 can be used as a positioning mark. Due to the provision of the colored layers 28, leakage of light can be suppressed more efficiently compared to a mark formed of only the notch 36.

The display device according to this embodiment is a liquid crystal display device and hence, the display device includes a backlight 50 which overlaps with the liquid crystal display panel 10 and supplies light to the liquid crystal display panel 10. FIG. 1 shows a light guide plate 42 and an optical sheet 44 which constitute parts of the backlight 50. The light guide plate 42 is provided for converting light emitted from a light emitting diode (not shown in the drawing) which constitutes a point light source into light of a surface light source and for irradiating the light of the surface light source to the liquid crystal panel 10. The optical sheet 44 includes a diffusion sheet, a prism sheet and the like. A reflection sheet 46 is arranged below the light guide plate 42 (on a side opposite to the group of optical sheets 44). An upper surface of the light guide plate 42 faces the liquid crystal display panel 10 so that light irradiated from the surface of the light guide plate is incident on the liquid crystal display panel 10. Light which is irradiated from the light guide plate 42 in the direction toward the reflection sheet 46 is reflected on the reflection sheet 46 and returns to the light guide plate 42.

The liquid crystal display device includes a frame 48 which is made of a resin, for example. The frame 48 is formed in a frame shape, and the backlight 50 is arranged inside the frame 48. The liquid crystal display panel 10 is mounted on the frame 48. An edge portion of the liquid crystal display panel 10 and the frame 48 are adhered to each other using a light-blocking double-sided adhesive tape 52. An upper frame 54 made of metal is mounted on upper portions of the liquid crystal display panel 10 and the frame 48, and a lower frame 56 made of metal is mounted on a lower portion of the frame 48.

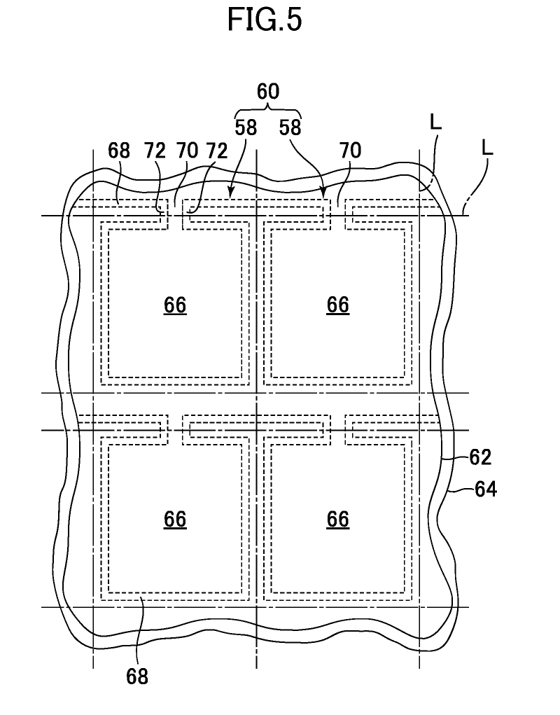

FIG. 5 is a view for explaining a method for manufacturing the display device according to the embodiment of the present invention. The method for manufacturing the display device includes a step of preparing empty cells 58. In this embodiment, a plurality of cells 58 are manufactured collectively by multipiece simultaneous manufacturing. FIG. 5 shows a multipiece-simultaneous-manufacturing cell 60 where the plurality of cells 58 are provided in the form of an integral body. The multipiece-simultaneous-manufacturing cell 60 includes a first large-sized substrate 62 from which the first substrates 12 are formed by cutting, and a second large-sized substrate 64 from which the second substrates 14 are formed by cutting, and the first large-sized substrate 62 and the second large-sized substrate 64 are arranged to face each other in an opposed manner with a gap formed therebetween.

A seal material 68 is arranged between the first large-sized substrate 62 and the second large-sized substrate 64 so as to define a plurality of spaces 66. The seal material 68 includes portions each of which is to be assembled into the individual cell 58, and a portion of the seal material 68 which is assembled into two or more cells 58 is continuously formed. To be more specific, in the individual cells 58, the seal material 68 surrounds the space 66 into which the liquid crystal material 18 is injected, and includes a pair of opposedly facing wall portions 72 which faces each other in an opposed manner with a gap formed therebetween so as to define a flow passage 70 which is communicated with the space 66. The individual cells 58 can be obtained by cutting the first large-sized substrate 62 and the second large-sized substrate 64 along cutting lines L. In the cutting process, the seal material 68 is also cut in conformity with the individual cells 58. By cutting the pair of opposedly facing wall portions 72, the slit 24 (see FIG. 3) of the seal 22 which is assembled into each cell 58 is formed.

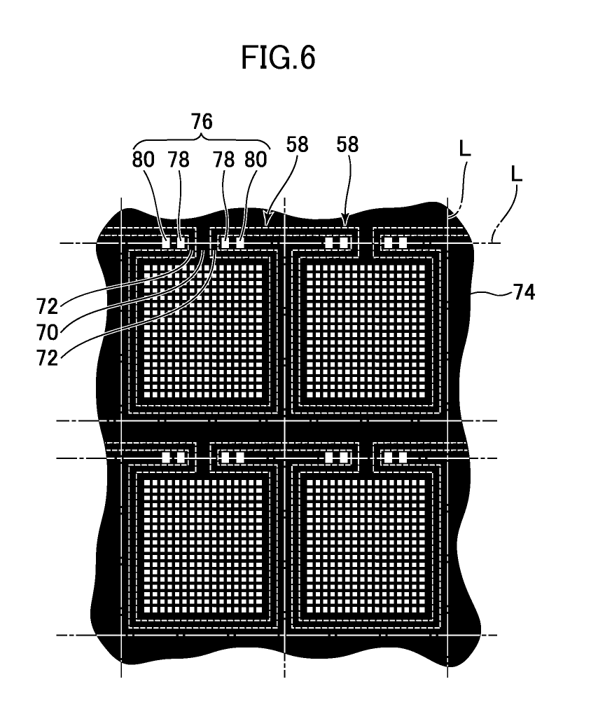

FIG. 6 is a view for explaining a black matrix material 74 for the multipiece-simultaneous-manufacturing cell 60 shown in FIG. 5. The black matrix material 74 includes portions each of which is to be assembled into the individual cell 58, and the portion which is assembled into two or more cells 58 is continuously formed. Through holes 76 are formed in the black matrix material 74 such that the through holes 76 partially overlap with the portions of the black matrix material 74 which are assembled into the individual cell 58. The through holes 76 are formed at positions which sandwich the pair of opposedly facing wall portions 72 of the seal material 68. In the example shown in FIG. 6, another pair of second through holes 80 is formed such that another pair of second through holes 80 further sandwiches the pair of first through holes 78 which sandwiches the pair of opposedly facing wall portions 72. By cutting the through holes 76, the above-mentioned notches 36 (see FIG. 4) are formed.

The cell 58 which is cut out from the multipiece-simultaneous-manufacturing cell 60 includes, as shown in any one of FIG. 3 to FIG. 6, the first substrate 12, the second substrate 14 which faces the first substrate 12 in an opposed manner, and the seal 22 which surrounds the space 66 formed between the first substrate 12 and the second substrate 14 and includes the slit 24. The colored layers 28 of plural colors (see FIG. 2) and the black matrix 30 are formed on the first substrate 12. The black matrix 30 includes the frame-shaped portion 34 which surrounds the image display region 32. The frame-shaped portion 34 has the notches 36 in respective regions thereof which form a pair and sandwich the slit 24 on an outer side thereof, and is formed so as to cover the periphery of the first substrate 12 except for the notches 36 where the frame-shaped portion 34 does not cover the periphery of the first substrate 12. The colored layer 28 of at least one color is arranged in the notch 36.

The method for manufacturing the display device includes a step of injecting the liquid crystal material 18 into the empty cell 58. The liquid crystal material 18 is injected into the space 66 surrounded by the seal 22 through the slit 24 of the seal 22. By immersing the slit 24 in the liquid crystal material 18 in a vacuum atmosphere and, thereafter, by releasing a vacuum thus restoring an atmospheric pressure, the liquid crystal material 18 is sucked into the inside of the vacuum space 66.

Further, using the colored layer 28 of at least one color arranged in the notch 36 as a mark, the slit 24 of the seal 22 is sealed by the end-sealing material 26. For example, as shown in FIG. 4, the first notch 38 and the second notch 40 are formed in the respective regions which sandwich the slit 24 of the seal 22 therebetween and hence, the end-sealing material 26 is formed such that an end portion of the end-sealing material 26 terminates between the first notch 38 and the second notch 40 (see FIG. 3).

According to this embodiment, the colored layer 28 is arranged in the notch 36 formed in the black matrix 30 and hence, the colored layer 28 can be used as a positioning mark for providing the end-sealing material 26. Due to the provision of the colored layer 28, leakage of light can be suppressed more effectively compared to a mark formed of only the notch 36.

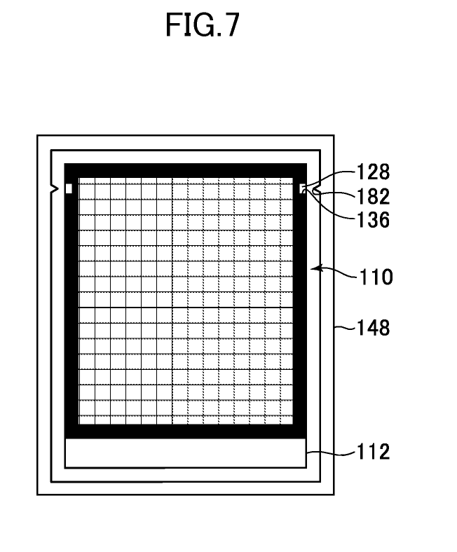

FIG. 7 is a view showing a modification of this embodiment. In this modification, a display device includes a frame 148 which surrounds a substrate 112. The frame 148 includes marks 182 which face notches 136 in an opposed manner. That is, colored layers 128 which are arranged in the notches 136 of a black matrix 130 are used as positioning marks between the frame 148 and a display panel 110. In this manner, the usage of the colored layers 128 arranged in the notches 136 are not particularly limited.

While there have been described what are at present considered to be certain embodiments of the invention, it will be understood that various modifications may be made thereto, and it is intended that the appended claims coverall such modifications as fall within the true spirit and scope of the invention.

What is claimed is:

1. A display device comprising:
a substrate which has an image display region;
colored layers of plural colors which are arranged in rows on the substrate and constitute a color filter in the image display region; and
a black matrix which is provided for preventing leakage of light as well as color mixing between the colored layers arranged adjacent to each other, wherein
the black matrix includes a frame-shaped portion which surrounds the image display region,
the frame-shaped portion is formed such that the frame-shaped portion has a notch on an outer side thereof and covers a periphery of the substrate except for the notch where the frame-shaped portion does not cover the periphery of the substrate, and
the colored layer of at least one color is arranged in the notch.

2. The display device according to claim 1, wherein the plural colors includes at least three colors consisting of red, green and blue, and at least the blue colored layer is arranged in the notch.

3. The display device according to claim 1, wherein the plural colors include at least three colors consisting of red, green and blue, and the colored layers of remaining colors after removing at least one color from the three colors are arranged in the notch.

4. The display device according to claim 1, wherein the colored layers of two or more colors are stacked in the notch.

5. The display device according to claim 1, further comprising:
a second substrate which faces, assuming that the substrate is a first substrate, the first substrate;
a liquid crystal material which is interposed between the first substrate and the second substrate;
a seal which surrounds the liquid crystal material between the first substrate and the second substrate and includes a slit; and
an end-sealing material which closes the slit in the seal, wherein
the black matrix has the notch in respective regions which form a pair and sandwich the slit therebetween.

6. The display device according to claim 1, further comprising a frame which surrounds the substrate, wherein
the frame has a mark which faces the notch in an opposed manner.

7. A method for manufacturing a display device which includes: a first substrate which has an image display region; colored layers of plural colors which are arranged in rows on the first substrate and constitute a color filter in the image display region; a black matrix which is provided for preventing leakage of light as well as color mixing between the colored layers arranged adjacent to each other; a second substrate which faces the first substrate in an opposed manner; and a seal which surrounds a space formed between the first substrate and the second substrate and includes a slit, the black matrix including a frame-shaped portion which surrounds the image display region, and the frame-shaped portion being formed such that the frame-shaped portion has a notch in respective regions which form a pair and sandwich the slit on an outer side of the frame-shaped portion and covers a periphery of the first substrate except for the notch where the frame-shaped portion does not cover the periphery of the first substrate, the method comprising the steps of:
preparing an empty cell where the colored layer of at least one color is arranged in the notch;
injecting a liquid crystal material into the empty cell; and
sealing the slit in the seal by an end-sealing material using the colored layer of at least one color arranged in the notch as a mark.
